(19) United States
(12) Patent Application Publication
(10) Pub. No.: US 2012/0296637 A1
(43) Pub. Date: Nov. 22, 2012

(54) METHOD AND APPARATUS FOR CALCULATING TOPICAL CATEGORIZATION OF ELECTRONIC DOCUMENTS IN A COLLECTION

(76) Inventors: Edwin Lee SMILEY, Santa Cruz, CA (US); Tom J. Santos, San Jose, CA (US)

(21) Appl. No.: 13/472,362

(22) Filed: May 15, 2012

Related U.S. Application Data
(60) Provisional application No. 61/488,648, filed on May 20, 2011.

(51) Int. Cl. G06F 17/27

(52) U.S. Cl. 704/9

(57) ABSTRACT

A computer implemented method calculates topical categorization of electronic documents in a collection. A processor applies a metric to categorize semantic distance between two sections of a document or between two documents. The processor executes a topic algorithm using the categorization provided by the metric to determine topic boundaries. Topics are extracted based upon the topic boundaries; and the extracted topics are compared for similarity with topics in other documents for organizational and research purposes.

### CROSS REFERENCE TO RELATED APPLICATIONS

This application claims priority to U.S. provisional patent application Ser. No. 61/488,648, filed May 20, 2011, which application is incorporated herein in its entirety by this reference thereto.

### BACKGROUND OF THE INVENTION

1. Technical Field

The invention relates to the categorizing of electronic documents. More particularly, the invention relates to calculating topical categorization of electronic documents in a collection based upon variational behavior of semantic distances between sections or partitions and positions within a document in view of the interval located between transition points.

2. Description of the Background Art

In many applications involving search, research, categorization, recommendation engines, and the like it is useful to dissect documents into components by topic. Topics may be indicated by clear breaks indicated by chapter headings, metadata, and the like, but they are often present inside of such divisions or, in some cases, such clear indications are missing. Also, the ostensible subject of documents, as might be indicated by Dewey Decimal or Library of Congress classifications, is a sort of average which may hide areas of correspondence between sections within documents. Topical division is also significant in research by revealing these unexpected connections.

Documents themselves may consist of sequences of words in text, but they may also be any sequence of meaningful tokens that can be sequentially represented on a computer, such as mathematical formulas or musical scores, etc.

U.S. Pat. No. 7,130,837 to Tsochantaridis et al. states (the '837 patent):

“In long text documents, such as news articles and magazine articles, a document often discusses multiple topics, and there are few, if any, headers. The ability to segment and identify the topics in a document has various applications, such as in performing high-precision retrieval. Different approaches have been taken. For example, methods for determining the topical content of a document based upon lexical content are described in U.S. Pat. Nos. 5,659,766 and 5,687,364 to Saund et al. Also, for example, methods for accessing relevant documents using global word co-occurrence patterns are described in U.S. Pat. No. 5,675,819 to Schuetze.

One approach to automated document indexing is Probabilistic Latent Semantic Analysis (PLSA), also called Probabilistic Latent Semantic Indexing (PLSI). This approach is described by Hofmann in “Probabilistic Latent Semantic Indexing”, Proceedings of SIGIR '99, pp. 50-57, August 1999, Berkley, Calif., which is incorporated herein by reference in its entirety.

Another technique for subdividing texts into multi-paragraph units representing subtopics is TextTiling. This technique is described in “TextTiling: Segmenting Text into Multi-paragraph Subtopic Passages”, Computational Linguistics, Vol. 23, No. 1, pp. 33-64, 1997, which is incorporated herein by reference in its entirety.

A known method for determining a text's topic structure uses a statistical learning approach. In particular, topics are represented using word clusters and a finite mixture model, called a Stochastic Topic Model (STM), is used to represent a word distribution within a text. In this known method, a text is segmented by detecting significant differences between Stochastic Topic Models and topics are identified using estimations of Stochastic Topic Models. This approach is described in “Topic Analysis Using a Finite Mixture Model”, Li et al., Proceedings of Joint SIGDAT Conference on Empirical Methods in Natural Language Processing and Very Large Corpora, pp. 35-44, 2000 and “Topic Analysis 50 Using a Finite Mixture Model”, Li et al., IPSJ SIGNotes Natural Language (NL), 139(009), 2000, each of which is incorporated herein by reference in its entirety.

A related work on segmentation is described in “Latent Semantic Analysis for Text Segmentation”, Choi et al, Proceedings of the 2001 Conference on Empirical Methods in Natural Language Processing, pp 109-117, 2001, which is incorporated herein by reference in its entirety. In their work, Latent Semantic Analysis is used in the computation of inter-sentence similarity and segmentation points are 60 identified using divisive clustering.

Another related work on segmentation is described in “Statistical Models for Text Segmentation”, Beeferman et al., Machine Learning, 34, pp. 177-210, 1999, which is incorporated herein by reference in its entirety. In their work, a rich variety of cue phrases are utilized for segmentation of a stream of data from an audio source, which may be transcribed, into topically coherent stories. Their work is a part of the TDT program, a part of the DARPA TIDES program.”

The '837 patent itself concerns “systems and methods for determining the topic structure of a document including text [that] utilize a Probabilistic Latent Semantic Analysis (PLSA) model and select segmentation points based on similarity values between pairs of adjacent text blocks. PLSA forms a framework for both text segmentation and topic identification. The use of PLSA . . . [is thought to provide] an improved representation for the sparse information in a text block, such as a sentence or a sequence of sentences. Topic characterization of each text segment is derived from PLSA parameters that relate words to “topics”, latent variables in the PLSA model, and “topics” to text segments . . . . Once determined, the topic structure of a document may be employed for document retrieval and/or document summarization.”

### SUMMARY OF THE INVENTION

Embodiments of the invention use the variational behavior of the density of semantic distances between sub-components of an electronic document within a collection to determine transition points between topics as a means of organization, topical analysis, and comparison between topics in different documents within the collection.

Embodiments comprise a computational algorithm that behaves as a measure of how close documents or adjoining document sections are to each other in topic. Although there are many approaches to understanding the meaning of subject matter of texts and portions of texts, such as keyword or vocabulary analysis, or trained neural networks, the invention allows considerable information to be obtained without any understanding of the underlying data because there are mathematical methods, such as the document sketching technique disclosed in U.S. Pat. No. 7,433,869 (Method and Apparatus for Document Clustering and Document Sketching), and well understood data compression comparison algorithms to obtain semantic distance. That additional methods could be used to augment the accuracy of semantic distance does not in any way change the originality of the approach which yields an automated way of detecting topic boundaries. Because they are tied to a given semantic distance, once topics are extracted, they can be compared for similarity with topics in other documents for organizational and research purposes. Additionally, the invention can be used for supplying chapter/heading generation for documents that do not possess it, allowing enhanced utility of client rendering software; or using the supplied chapter/heading information as input into characterization algorithms.

In an embodiment, the invention comprises one or more computer systems housing collections of documents, one or more computer systems involved in the analysis or correlation of documents, one or more computer systems involved in computing topical boundaries, and one or more computer systems involved in rendering such documents.

For analysis systems to divide an individual document into topics, a document is considered to be an ordered n-tuple that consists of ordered semantically significant tokens, and where the order of the tokens is semantically significant. The term of art “words” is used herein without any loss of generality, keeping in mind that other kinds of sequenced tokens, such as musical scores, also fit into this model.

A semantic metric is defined that functions to measure the semantic distance between two groups of words, having the intuitive sense that more and more similar word groups have smaller and smaller distances, and that more and more dissimilar groups would have larger and larger distances, and that they are size invariant, i.e. normalized, in the sense that distance measures are not skewed by the size of the compared groups, or by the difference in the sizes in the two groups being compared. And further, that the semantic distances obey, at least as a computationally useful approximation, the mathematical properties of a metric:

a. Identity;

b. Symmetry; and

c. Subadditivity.

Assuming that a useful semantic distance is defined, the invention provides a natural measure of topics. For instance, a normalized compression distance that follows the three metric conditions above systematically assigns greater semantic distances to passages inserted from one document to another than it does to passages within the same original document, even though such a metric makes no assumption about vocabulary or meaning. By computing the distance given by the metric between successive rolling word groups it is possible to obtain a natural semantic density centered on each pair of words. This is used as a term of art on the basis that the density of semantic distances indicates the density of disparate lines of thought, rather than similar lines of thought. The higher the semantic density, the more the topicality varies in that neighborhood

A key and essential idea of the herein disclosed method consists in observing that:

a. All things being equal, any arbitrary partition of a document, where there are additional partitions on the left and right, is more likely to belong in the same topic with the side that is closer to it in semantic distance, and

b. The semantic density experiences local maxima at or near the word boundaries that define topic transitions, and in adopting empirical constraints to filter out minor variations and further, that closely related portions of a document have low semantic density. In the case of rolling groups of a given size, good results have been achieved for topic divisions by providing that topic boundaries occur at the word boundary which is offset by an amount that is approximately equal to the square root of the group size in words before each solution, where the solutions is given by:

i. The first derivative (slope) is zero (local extremum condition);

ii. The second derivative is negative (not a minimum);

iii. The maximum is above a certain threshold value, such as say, at least a defined fraction of the way between the global maximum and the global minimum; and

iv. Because the invention concerns discrete values, it uses difference equations to approximate these ideal derivatives.

### BRIEF DESCRIPTION OF THE DRAWINGS

FIG. 1 is a graph showing a comparison of semantic space when using documents vs. topics;

FIG. 2 is a diagram that shows relatedness of documents based upon semantic distance;

FIGS. 3A-3C provide a flow diagram of a specific implementation of a compression algorithm used in connection with an embodiment of the invention;

FIG. 4 is an example of the use of a pre-transformation prior to using topical analysis and similarity distance according to the invention;

FIG. 5 is an illustration of differential adhesion used in recursively repartitioning topic boundaries according to the invention;

FIGS. 6A-6D comprise a flow diagram showing the primary algorithm for determining boundaries for topics according to the invention;

FIG. 7 is an illustration of rolling groups used in computing variations in semantic density according to the invention;

FIG. 8 is a graph of topical boundaries utilizing the variational behavior of semantic distance according to the invention;

FIG. 9 is a flow diagram showing a secondary algorithm for determining boundaries for topics according to the invention;

FIGS. 10A and 10B are flow diagrams showing an algorithm for a composite topics approach using the two algorithms, shown FIGS. 6A-6D and 9, in tandem according to the invention, as indicated;

FIG. 11 is a simplified diagram indicating a cosine distance threshold embodied as a D-dimensional hypercone in D-space as an application of the invention;

FIG. 12 is a simplified diagram indicating a range threshold embodied as a D-dimensional hypercube in D-space as an application of the invention;

FIG. 13 is a graph marked into coded sections showing sub-topic boundaries based on relatedness thresholds;

FIG. 14 is a graph marked into coded sections showing topic boundaries based on relatedness thresholds; and

FIG. 15 is a block schematic diagram of a machine in the exemplary form of a computer system within which a set of instructions for causing the machine to perform any one of the foregoing methodologies may be executed.

### DETAILED DESCRIPTION OF THE INVENTION

Embodiments of the invention consist of:

1. A metric, which categorizes the relationship, e.g. semantic distance, between two sections of a document or between two documents (described in greater detail below). Although there are many approaches to understanding the meaning of subject matter of texts and portions of texts, such as keyword or vocabulary analysis, or trained neural networks embodiments of the invention allow considerable information to be obtained without any understanding of the underlying data. That additional methods could be used to augment the accuracy of semantic distance does not in any way change the originality of the approach, which yields an automated way of detecting topic boundaries.

2. A topic algorithm, which uses the categorization provided by the metric to determine the boundaries of topics. Because they are tied to a given semantic distance, once topics are extracted, they can be compared for similarity with topics in other documents for organizational and research purposes.

### SUMMARY OF USEFULNESS OF THE INVENTION

One particular merit of the herein disclosed invention is that topic determination as described needs no intelligent analysis of vocabularies to derive latent semantics, being statistical in nature, and can therefore be readily used even in the absence of semantic information, and can also be extended in areas beyond text.

As an extreme example of the former, a corpus of sufficient length in an ancient language, or from an extraterrestrial signal, can be divided into topics, regardless of whether the meaning of the document is known by the analyzer, or even by anyone at all. As an example of the latter, a passage in one musical score, or mathematical paper, by the very systematic nature of its signs could be compared with another.

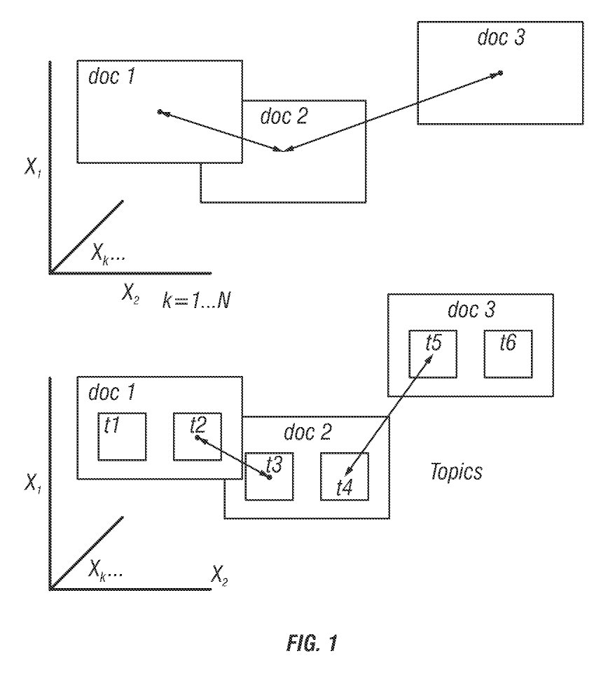

Traditionally, relatedness of documents has been seen as between the overall topic of each document that composes a semantic space which is capable of navigation. Topic determination can provide a richer set and more germane navigation of semantic space (see FIG. 1).

Metric: Relationship between two sections of a document or between two documents

We define a word sequence metric function as a distance function, s, which maps all word sequences x and y to a positive number and obeys the three metric axioms:
s(x,x)=0 (there is no self-distance)
s(x,y)=s(y,x) (distance is independent of order)
s(x,z)s(x,y)+s(y,z). (triangle inequality: no shortcuts)

Note that we use the broad definition of ‘word’ as a term of art to mean any semantically distinct token.

In addition, informally, we agree that for the metric to be meaningful as a semantic distance, we require, without defining rigorously what we mean by it, that for any documents x and y, as s(x,y) becomes smaller, the meaning of x, M(x), and the meaning of y, M(y), more closely approach each other; conversely the larger the value of s(x,y), the more dissimilar become the meanings M(x), M(y).

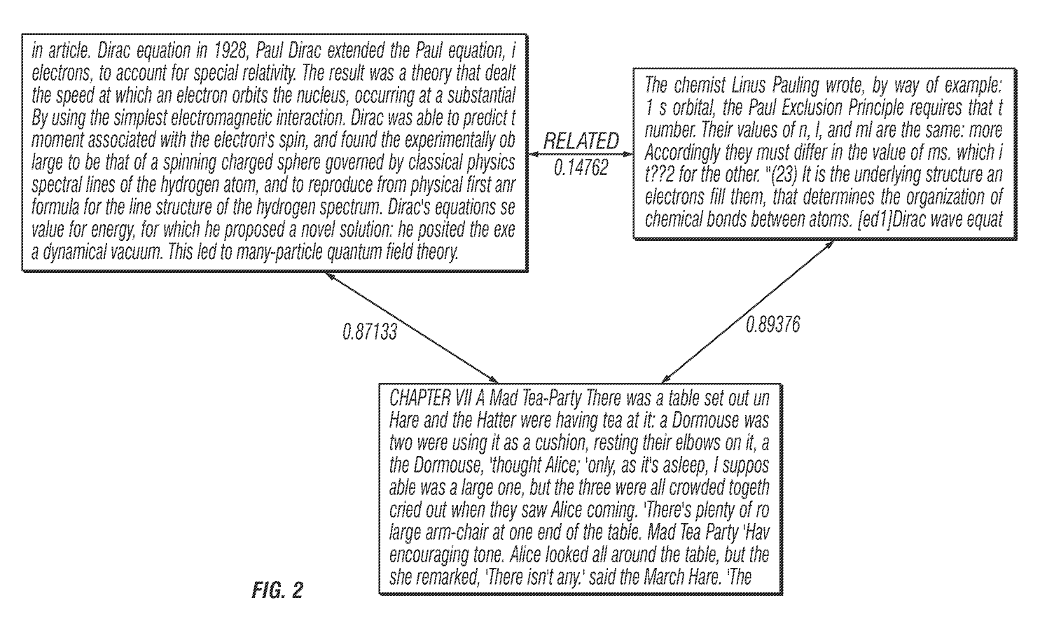

We also require this metric functions reasonably well regardless of scale, with the intuitive meaning that if two pairs of such sequences are many times larger than another pair that the word sequence metric give approximately the same value if the partners in one pair are about as related as those in the other. See FIG. 2.

We therefore agree to use the term ‘semantic distance’ as a metric applied to word sequences which obeys the above criterion. The semantic distance can be employed independently of what particular process uses it to determine topic boundaries or document taxonomies. Note that in an actual implementation we may be satisfied by fulfilling the above only approximately.

### Implementation

Embodiments of the invention use a compression algorithm as a means of constructing a word sequence metric. Any compression type that is optimized for non-randomized data, such as those that use a run-length encoding principle, are suitable. Embodiments of the invention can either use a standard library compression algorithm or implement a version optimized for this particular use.

A significant part of the compression process for the invention is the calculation of the compressed size. In implementation cases where the calculated size is available without completing the actual compression, only the calculated size need be used. Some embodiments use a particular GZIp compression library, which has a slightly faster implementation for computing compression length for a string than for producing the actual compressed string.

The naive idea of the distance measure is that two data elements, e.g. documents or document sections, compress better the closer their subject matter, but the Invention also takes into account the compression overhead of compressing absolutely identical data and backs it out, as well as scaling the measure against the size of the two data elements. This makes the measure behave more like a traditional distance measure between objects.

### A Specific Implementation

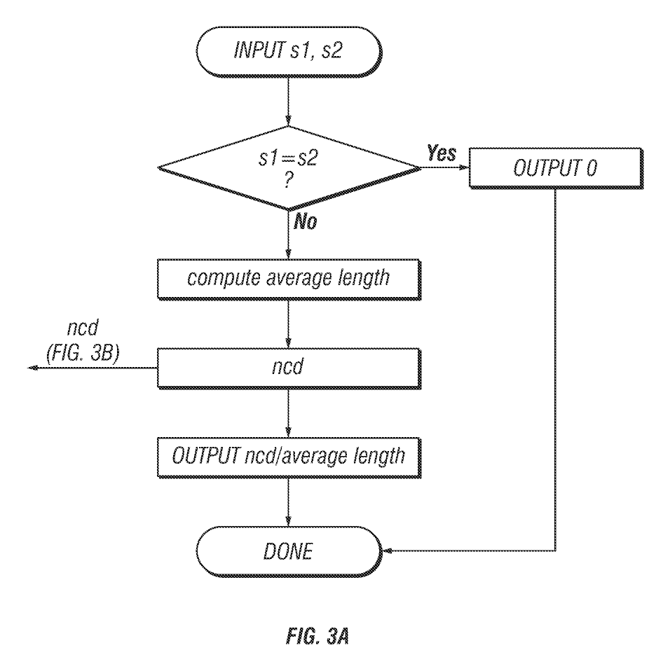

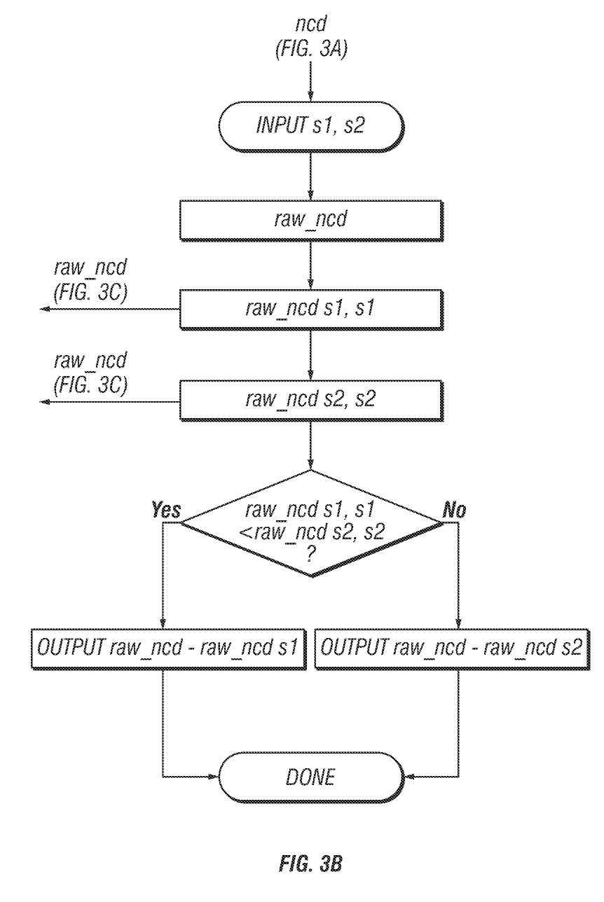

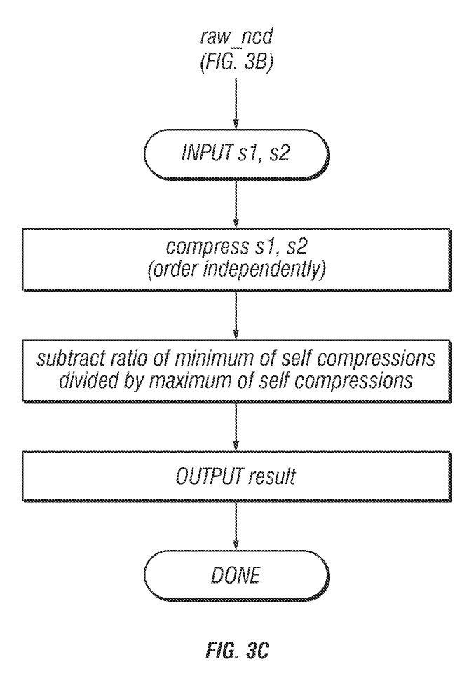

The invention can lead to several different implementations. The following pseudo code example embodies this embodiment (see FIGS. 3A-3C):

```
Given: s1, s2
distance = scaled_normalized_compression_distance(s1, s2)
scale normalized compression distance by average size
scaled_normalized_compression_distance(s1, s2)
  return 0.0 if equal
  average = (s1.length + s2.length)/2
  distance = normalized_compression_distance(s1, s2)/avg
  return distance
end
back out raw normalized self compression
normalized_compression_distance(s1, s2)
  r12 = raw_normalized_compression_distance(s1, s2)
  r11 = raw_normalized_compression_distance(s1, s1)
  r22 = raw_normalized_compression_distance(s2, s2)
  return r12 - minimum ( r11, r22)
end
compress independent of order and back out self-compression
raw_normalized_compression_distance(s1, s2)
  d12 = compression_length(s1, s2)
  d21 = compression_length(s2, s1)
  d11 = compression_length(s1, s1)
  d22 = compression_length(s2, s2)
  min = minimum(d11, d22)
  max = maximum(d11,d22)
  return (d12 + d21) / 2.0 − (min / max)
end
compression_length(s1, s2)
  t = concatenate(s1, s2)
  c = compress(t)
  return c.length
end
```

The invention can also make use of a normalizing transformation prior to calculation of the semantic distance. If tokens are of different types, but convey the same underlying semantic component, they can be normalized by an automated transformation.

Examples of this can include, but are not limited to:

a. Calculating semantic distance between newspaper articles in Italian and an existing collection of articles in English with a similar range of subject matter: the transformation would be an adequate machine translation;

b. Musical scores in some sequential notation would be machine-transposed into the same key prior to comparison; and

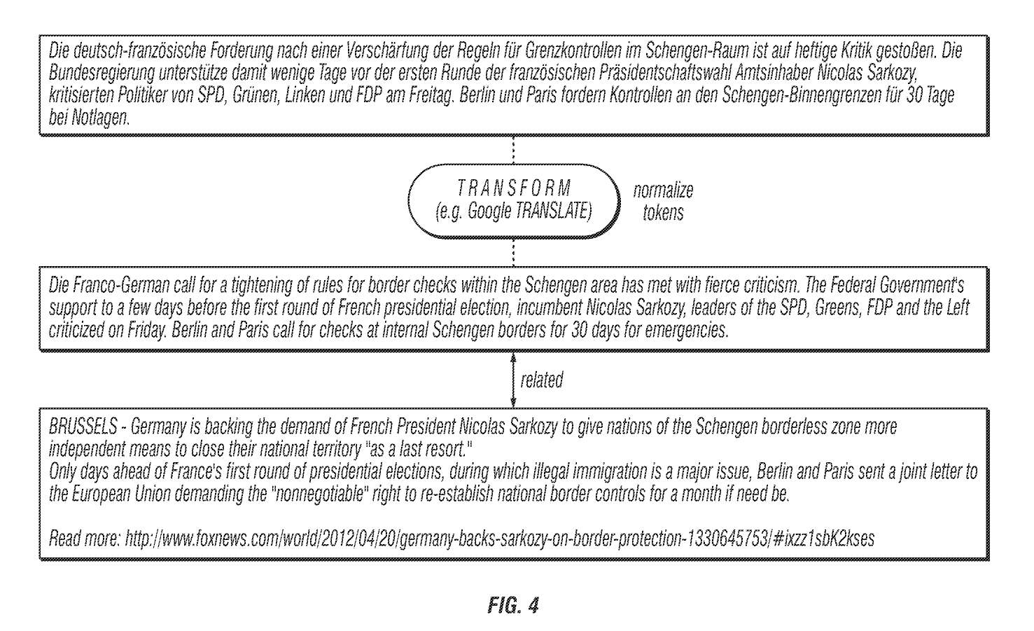

c. When using a text in a known vocabulary, an optimization would be a synonym list automatically applied against it to normalize vocabulary. See FIG. 4.

Compression based metrics can be used alone by the invention, or in combination with other semantically meaningful metrics. The point being that the invention's topical algorithms can be embodied using a compression based metric or in combination with other valid semantic metrics.

To give a specific case, let m₀ be the compression based metric function. If we used additional metric functions m₁ and m₂, . . . we could define a metric as a linear combination, for example

m(x,y)≡αm₀(x,y)+βm₁(x,y)+γm₂(x,y)

or we could use even more complex functional combinations. The invention does not require this to provide its primary utility, but it does include this case as a means of tweaking and optimization.

An example of a candidate for combination is the sketch technology of U.S. Pat. No. 7,433,869, supra, which is very efficient, and detects almost exact matches between text, but is not very good at detecting weak, rough, fuzzy matches. In such a case, one could apply it to determine the very close matches and then, if the close match was not found, apply a compression based metric, which is far better at determining degree of relatedness between loosely associated items.

The invention also includes a method of testing the effectiveness of semantic metrics and the accuracy of algorithms to achieve topic boundaries by insertion of non-sequitur passages. The phrase “non-sequitur document” is a term of art for any document deliberately composed out of topically divergent source documents. Where topic algorithms can be characterized by several free parameters, we also describe a method by which they can be set:

a. Create nested loops in which each of the free variables take different successive values;

b. In the inner loop compute the standard deviation of computed topic boundaries against the artificial boundaries we have created in the non-sequitur document and place the current parameter values into an associative array keyed by the standard deviation value;

c. When completed, select the lowest key, which will obtain the optimum value for all the free variables.

pseudo code

```
Given: test_text
Obtain: optimum values for all free parameters, O
initialize associative array A
for each value of p1
  for each value of p2
      ...
      for each value of pn
        topics = analyze(test_text)
        s = std_deviation(topics, expected_topics)
        put s=> {p1, p2, ...pn} into A
        end for
      ...
  end for
end for
O = A[min_key(A)]
```

We have found that a normalized compression distance, as described above, systematically assigns greater semantic distances to passages inserted from one document into another than it does to passages within the same document, even though such a metric makes no assumption about vocabulary or meaning, and are therefore justified in using this approach in automatically adjusting topical algorithms. See FIG. 2.

Using a size invariant metric, the invention can compare the semantic similarity of entire documents to extracted topics and to other documents. The invention includes the concept of size-normalization of the metric value to allow just this feature. See FIG. 1.

Topic Algorithm: Using that Categorization to Determine the Boundaries of Topics

The invention has several approaches to determining topic boundaries. Although the invention uses a compression metric for the purpose of deriving topic boundaries, using the methods we will describe below, they only require some well-behaved implementation of a semantic metric, and are independent of the specific implementation, as noted above.

1. Calculating topics by recursive division and differential adhesion based on semantic distances.

2. Secondarily, calculating topics using the variational behavior of semantic distances.

3. Resulting in a composite approach involving both 1 and 2 above.

### Topics by Recursive Division and Differential Adhesion Based on Semantic Distances

Rather than tracking changes in semantic density, we can also compute topic boundaries by successively subdividing a document into partitions and adhering the more closely related together into larger partitions.

Let us define a similarity threshold, and a topic partition threshold. These determine a minimum difference in similarity that is allowed between different topics, and a minimum size of topic.

This approach then consists of:

a. Dividing the document into three partitions, and

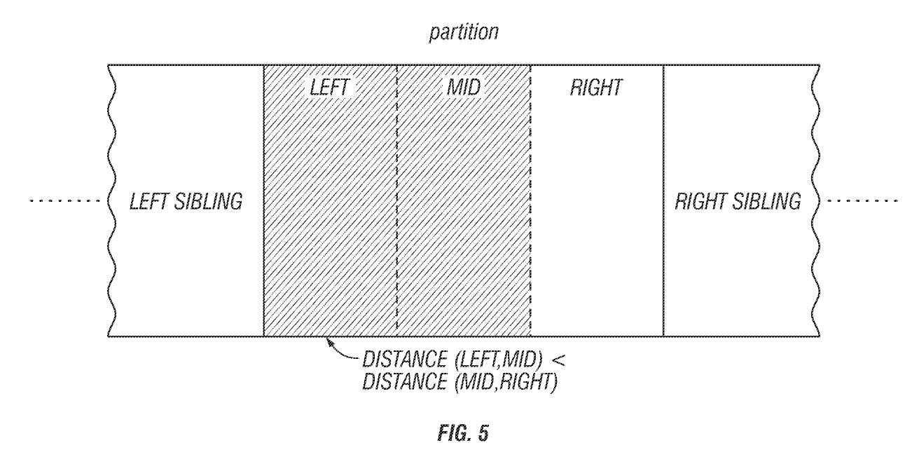

b. Joining the two that are most similar, based on the lower semantic distance between them. See FIG. 5.

c. Recursively partitioning the partitions in the same way until a threshold is reached, and

d. Testing the resulting partitions from c. against their neighbors and joining them if they are within the similarity threshold (parts b. and d. are why we use the term ‘adhesion’).

There are a number of parameters that may be adjusted for this algorithm:

a. Topic threshold

b. Similarity threshold

c. Number of rejoining passes made against the partitions.

Pseudo code: Topics by recursive division and differential
adhesion

```
Given: text
topics = analyze(text) array of topic-starts
topic_n = topic(n) n^{th}topic string for all n < topic-starts size
analyze
  create array
  topics create
  array words
  split text into
  words add zero to
  topics
  partition(0)
  for i from 0 to NUMBER_OF_REJOINS
    col
  late
  end
  return
topics end
partition(position)
  current_pos = position
  start =
  topics[position] end =
  topics[position + 1]
  size = (e − s)/3
  return if size < MIN_TOP_SIZE
  mid_start = start +
  size mid_end = start +
  2 * size
  left = topic(start,
  mid_start) mid =
  topic(mid_start, mid_end)
  right = topic(mid_end, end)
  left_dist = distance(left,
  mid) right_dist =
  distance(mid, right)
  if left_dist < right_dist
    new_pos = mid_end
  else if right_dist < left_dist
    new_pos = mid_start
    if has right neighbor at position
      delete from topics at position + 1
    end
  else
    new_pos = (end − start)/2
    if has left neighbor at position
      delete from topics at position + 1
      decrement current_pos
    end
    end
  insert new_pos into topic before index current_pos + 1
    for each in topics except current_pos
    partition i
  end
end
collate
  last_topic = “”
  last_index = 0
    for each index i in topics
    topic = topic last_index, i
    if i>0
      if distance(topic, last_topic) < MIN_SIM_DIFF
        delete from topics at i
      end
    end
    last_topic = topic
  end
end
topic(i, j)
    return join words from i to j
end
```

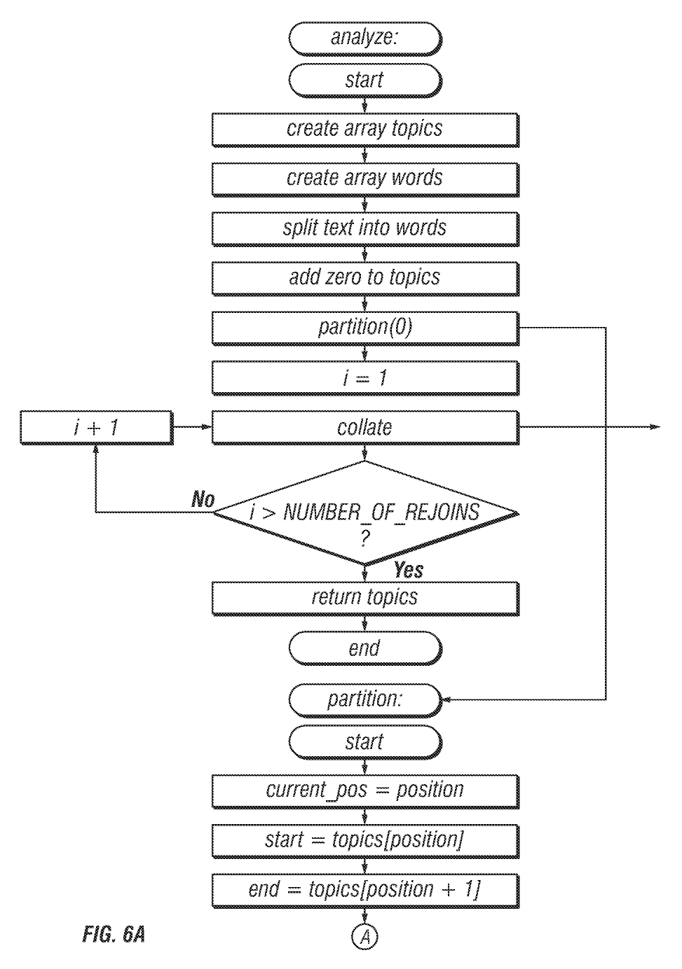

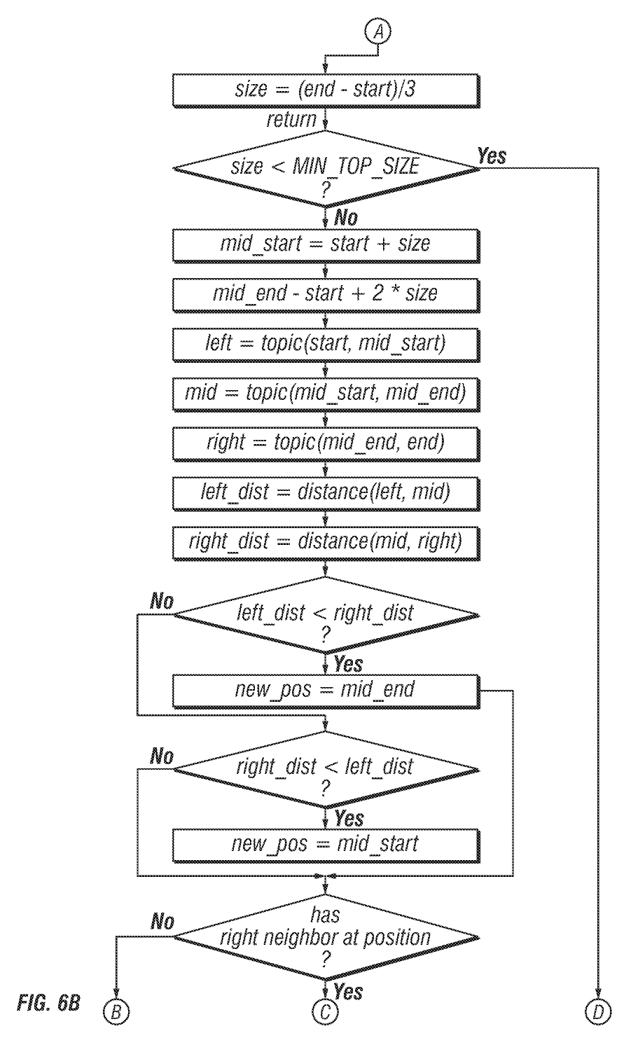

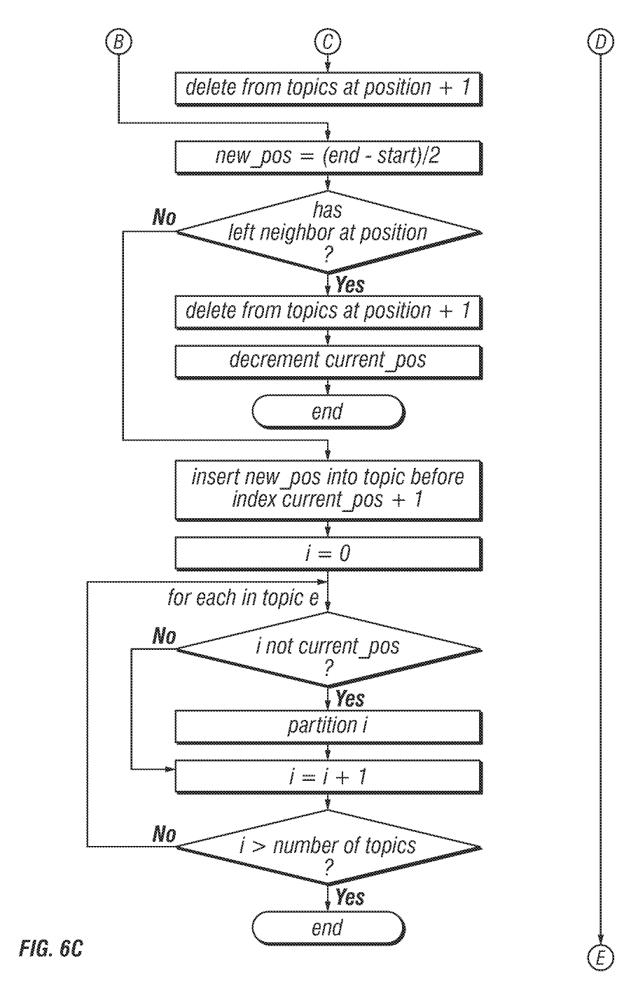

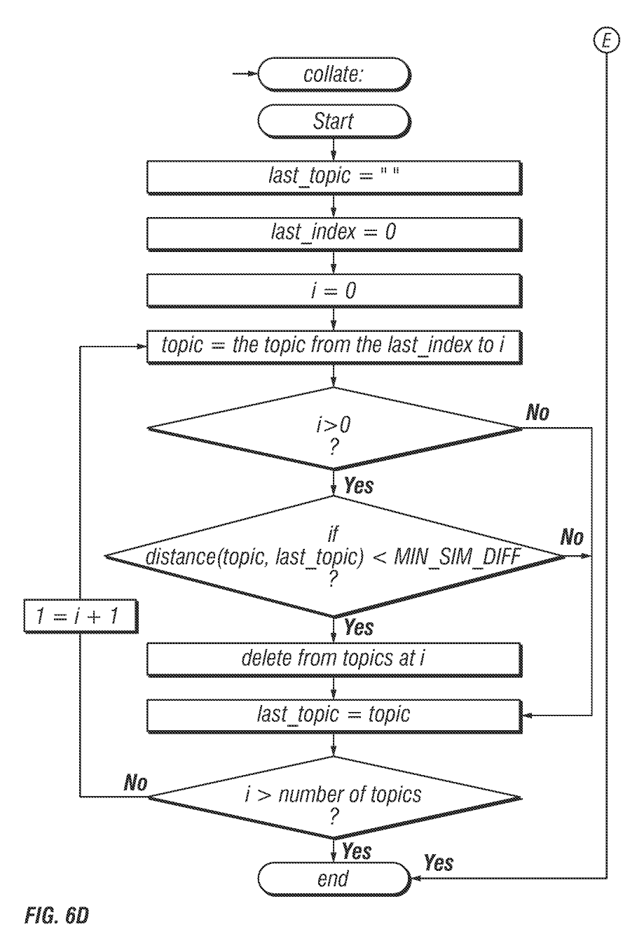

See FIGS. 6A-6D.

### Topics Using the Variational Behavior of Semantic Distances

The semantic density is how much disparate material appears in a given region. That means that where the matter is focused on a given topic, the semantic density is low. Where there is a variation, it is high.

The key and essential idea of this method consists in observing that:

a. The semantic density experiences local maxima at or near the word boundaries that define topic transitions, and

b. Adopting empirical constraints to filter out minor variation, and further,

c. That closely related portions of a document have low semantic density.

To measure the semantic density at a given point, that is to say a word or token, we use rolling groups. To smooth out intermittent variations that may mar the continuity of a topic instance we can employ a rolling average of semantic distances. Effectively this can be done by proper choice of scale for the word sequences. An explanation follows:

Two groups of a set size of words are created:

a. One is centered on the word in question, and

b. The other is an overlapping group centered on the adjoining word.

c. The semantic distance between the two overlapping groups is then taken.

d. This distance value, over all such successive groups is extremely sensitive to changes in topics, and represents the semantic density.

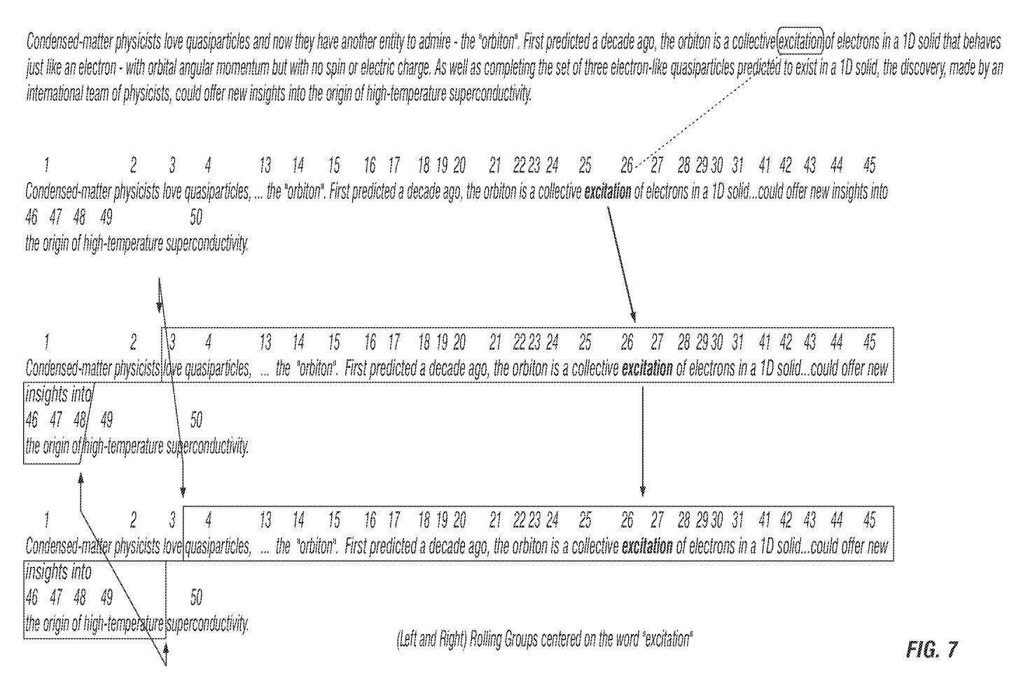

See FIG. 7.

In the case of rolling groups of a given size we have found quite good results for topic divisions by:

a. Using difference equations to approximate differential equations we use the following principles, based on the Extreme Values Theorem, to find that at a topic boundary:

b. The first derivative (slope) is zero (local extremum condition)

c. The second derivative is negative (not a minimum)

Geometrically, the slope is zero and the rate of change of the slope is negative.

In other words,

$$Maximum \text{:} \frac{d x}{d y} = 0 ; \frac{{d}^{2} x}{d {y}^{2}} < 0$$

d. The maximum is above a certain threshold value.

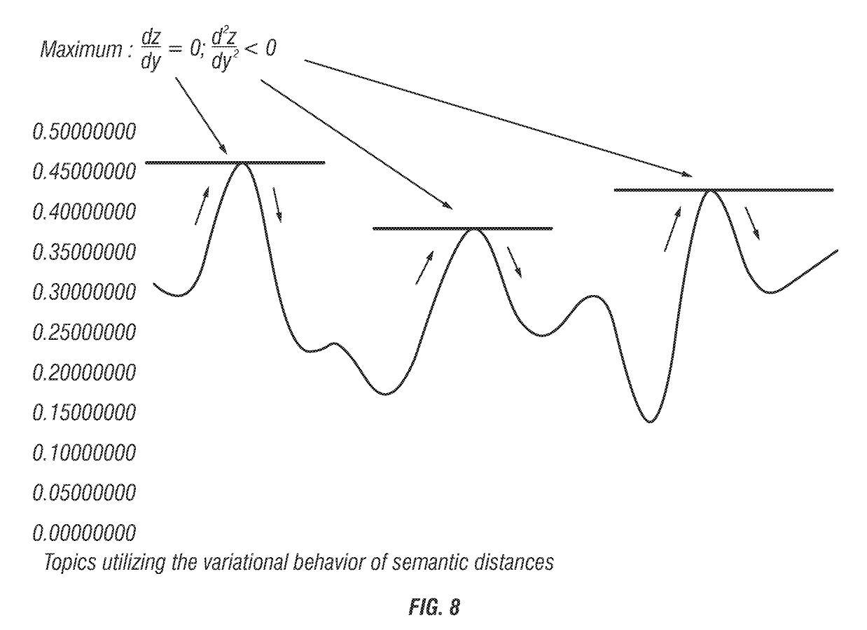

See FIG. 8.

To calculate this,

a. We compute the semantic density at each k, S(k), in the following way:

b. Define two texts composed of a group of G words,

xₖ=[k−G,k+G],xₖ₊₁=[k−G+1,k+G+1].

c. Using the metric, m, on each successive (k^{th}) word

S(k)=m(xₖ,xₖ₊₁).

d. We can then test each k in sequence, and add it to the list of maxima if it fulfills a difference equation approximating conditions where the first derivative (slope) is zero (local extremum condition) and the second derivative is negative (not a minimum).

pseudo code for computing document with n words:

```
create array S[ ] semantic densities
create array M[ ] maxima: topic boundaries
get semantic densities
for all k 1 to n
    x1=[k−G,... k+G] left group
    x2=[k−G+1,... k+G+1] right group
    S[k]=m(x1, x2)
get maxima
note that zero tests can be approximate
for all k 1 to n
    if S[k+1] −S[k] =0 and S[k+2] −S[k]<0 maxima
        store k in M
```

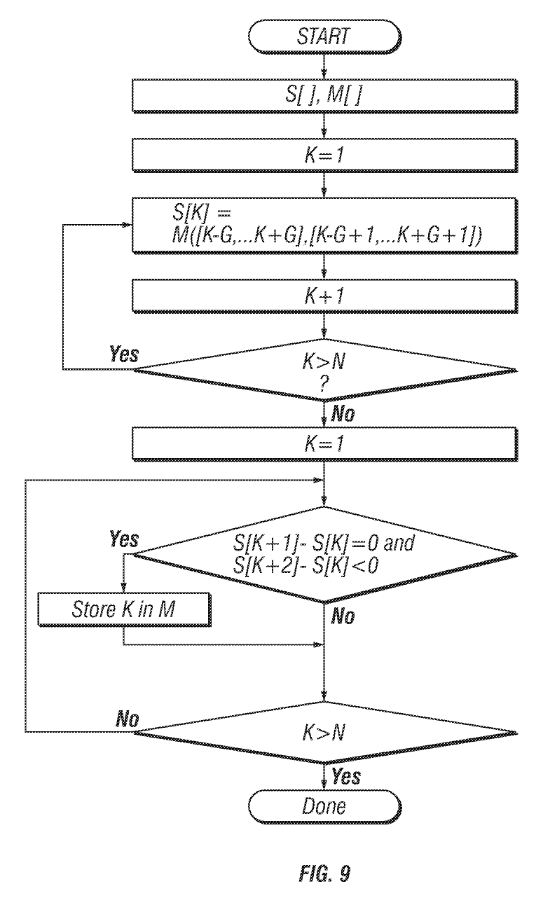

See FIG. 9.

### Composite Topics Approach

Our invention comprises a composite approach.

The recursive division algorithm is faster, but the variational behavior of semantic distances appears more accurate. We combine them in the following way:

1. Compute topic boundaries using recursive division and differential adhesion as above.

2. This outputs a set of approximate topic starts. See “topic boundaries using recursive division and differential adhesion” above.

3. In a small neighborhood of each approximate topic start;

a. Find the closest local maximum using the “variational behavior of semantic distances”, above.

b. Replace the approximate topic start with the local maximum.

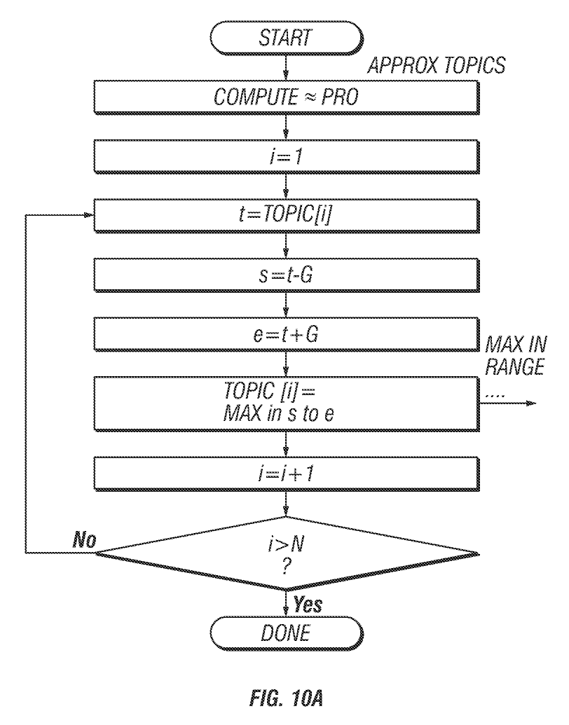

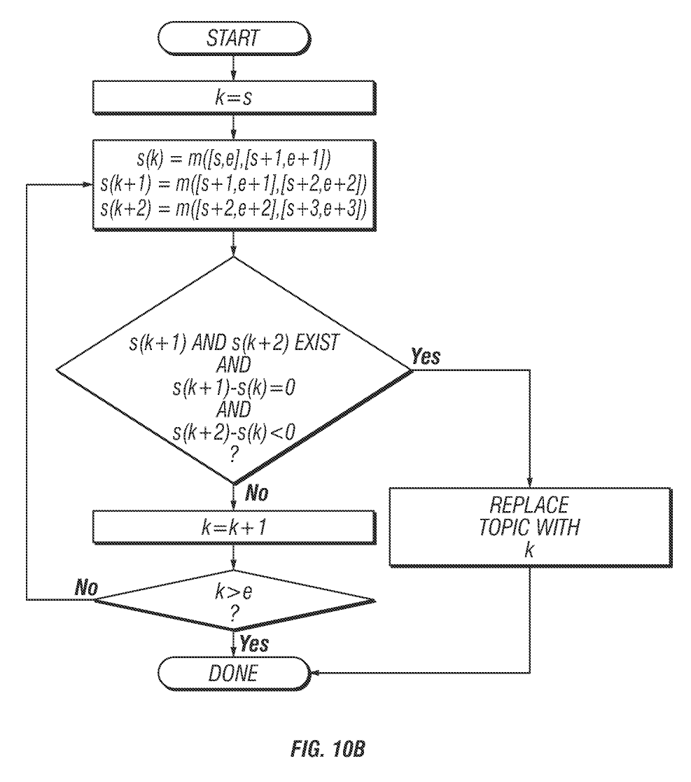

See FIGS. 10A and 10B.

4. This approach can be parameterized by size of the neighborhood and group size to adjust the optimum tradeoff.

5. An additional optimization can be made in more structured documents to replace calculated topic boundaries with natural breaks if sufficiently close to the calculated topic boundary. These natural breaks would be such things as sentence, paragraph and chapter boundaries. This would avoid a topic boundary being defined that “orphans” a few words (placing them in foster care of another topic).

### Use Cases

1. Unexpected results of higher value. Topical deviations from the average subject matter tend to get diluted in other approaches and may represent an unusual spin on the topic of research: these represent valuable discoveries which would be missed by others studying in the field.

Typically when doing research one attempts to do keyword or link based searches over a large collection of documents, and use the highest scores, or use general taxonomies such as Library of Congress classification for the foundational bibliography. On the other hand, if applications have a topical component, for which we use the term of art “topic aware”, they can provide additional utility. For example:

a. Imagine an author studying mid-19th century American recipes. A topic aware application directs them unexpectedly to a two page passage in a biography of Ulysses S. Grant describing his favorite recipes for camp food while on campaign.

b. Imagine a student researching the history of logic for a paper directed by a topic aware application to sections of works concerning Lewis Carroll (aka Charles Dodgson, a mathematician who authored countless works concerning logic, geometry, voting theory and what later came to be called game theory.) They are able to include quotation of a surprising and useful passage where the author of Alice in Wonderland attempted to buy a calculating machine from Charles Babbage.

c. Imagine a string theorist who discovers an unexpected related topic that embodies a similar mathematical model in a study of turbulent materials or chemical reactions. He may be unable to directly observe the behavior in his model, but can employ actual experimental observations in the analogous domain that are too mathematically recondite to work out theoretically. There have been several similar cases where fundamental research has been based on models that use an emergent secondary phenomenon. Tests have indicated the possibility of separating non-relativistic and relativistic quantum theory topics in a document based on compression based similarity measures alone, so it is a realistic suggestion that topic discovery based on the invention could uncover such fruitful correlations between topics within ostensibly divergent technical subject matter.

2. Decipherment. Several documents in an unknown script are discovered by archeologists. They are encoded digitally and separated into topics. The closer topics can be placed side by side, and workers in the field can investigate common stems and phrases in the corresponding passages.

3. Social Recommendation Engines. Typically such engines use a combination of document, document-subject and friend correlations, but particular topics that underlie the correlated choices may remain hidden in a non-topic-aware application.

a. Two friends or acquaintances who prefer stories of arduous sea travel, but only when they include topics concerning exotic animals. A topic aware application should give such books a much higher score than the conventional assignment by subject matter/friend association alone.

b. It should be possible to infer that certain topics would be of interest based on topics of others in the social graph, as indicated in the previous example.

c. Inverse recommendations. Suggest friends to add to social graph based on topicality that might not be as closely implied by overall subject matter.

4. Plagiarism Detection. If a topic is lifted essentially unaltered and placed in a larger document, it should match up with an extremely significant (low semantic distance) score when compared with the source topic.

### Applications: Uses and Extensions

Some of the applications, uses and extensions of these ideas:

1. Creating topic gist sentences

2. Creating semantic spaces

3. Creating user navigational model

Application and Extensions of the Invention: Create Topic Gist Sentences

1. Calculate border positions of topic transitions in the usual way. We assume, rounding, as necessary, to nearest sentence start and end positions.

2. Let there be N topics, and an array of topics Tᵢ: i=0, 1, 2 . . . N−1. Now let sᵢⱼ be the j sentences in Tᵢ.

We calculate an array of gists, Ai, In the following way:

pseudo code for calculating gist sentences

```
for each i
    k = 0
    v = MAX
    for each j
        if ^{s}ij.length>MIN_SIZE
        Compute the distance m = d( T [symbol]  sᵢⱼ)
        if m<v
            v=m
            k = j
      end
      Aᵢ = sᵢₖ
end [symbol]
indicates data missing or illegible when filed
```

3. We have our gists for each topic, i: Aᵢ=gist(Tᵢ)

### Application and Extensions of Invention: Creating Semantic Spaces

If we could assign D orthonormal components to each document or topic (in a D dimensional “space”), we could use

$$m ( X , Y ) = {\sum }_{i = 1}^{D} {( xi - yi )}^{2}$$

and calculate the distance between any two, indirectly, using only D subtractions, D multiplications, and D additions.

With this in hand, we can quickly calculate the relatedness of any document or topic to any other within a collection with a quickly calculated metric, instead of calculating a series of compressions.

Applications include academic research, smart bookshelves, search, patent discovery, and recommendation engines.

### An Extension to the Invention to Create a Vector Space Model.

A method whereby this could be achieved using topics and sampling is outlined below.

1. Let N be the size large number of documents in a set S={s₁, . . . s_{N}} chosen with a broad spread of topics, and Mavg the average number of topics per document.

2. Let us set K as the size of the sample space, and D as the required dimensionality with K≧D²/2+D.

3. We randomly select a sample of n=K/M_{avg} documents, with an expected value of k nM_{avg}=M_{avg}K/M_{avg}=K topics. We'll call this topic set T={t₁, . . . tₖ}.

4. Then, select a second random sample of K documents. Call this set U={u₁, . . . u_{K}}.

5. Compute the semantic distance for all combinations.

```
for i from 1 to k do
      for j from 1 to K do
          dij = m(ti,uj)
    next j
next i
```

6. To each element of tᵢ of T compute the sample standard deviation of distances to the other topics.

7. Choose the basis elements, B={b₁, . . . b_{D}}consisting of the D largest deviation values in T. These topics can serve as the basis for a coordinate system. Any text can be given a position in this system by computing the distance of the text from the basis elements.

8. Assign all the N documents vectors with the D components corresponding to the distance between those documents and the basis elements, so that to each document, sₖ, there corresponds a vector: xₖ(m(b₁,δₖ), . . . m(b_{D},δₖ))=(k₁, . . . k_{D})

9. Compute the L=D²/2+D linearly independent values of gᵢⱼ in the linear metric function

$$m ( {x}_{i} , {x}_{j} ) = {\sum }_{i = 1}^{D} {\sum }_{j = 1}^{D} {g}_{ij} {x}_{i} {x}_{j}$$

in the following way:

Choose a random sample of L+1 documents from U and choose one arbitrarily and compute the semantic distance to all of the others. There are then L equations in L unknowns which can be solved straightforwardly for the gij.

10. Given the metric coefficients, gᵢⱼ and the basis vectors, we can calculate a new set of normal orthogonal basis vectors, said normalization using orthogonalization schemes such as the stabilized Gram-Schmidt process, Householder transformations, Givens rotations, etc.

11. This orthonormal basis consists of linear combinations of the original basis set. As noted before, we could then use

$$m ( X , Y ) = {\sum }_{i = 1}^{D} {( xi - yi )}^{2}$$

and calculate the distance between any two, indirectly, using only D subtractions, D multiplications, and D additions.

As soon as documents or topic texts (topical analysis performed when a document is added) are introduced into the corpus, their orthonormal coordinates are recorded. As soon as this is done, the relatedness or semantic distance to any other member of the corpus are efficiently computed by the simple root-of-the-sum of D squared differences. This computation can be obtained rapidly, even for a very large number of dimensions. See FIG. 1.

Note: There are a couple of optimized approaches to pre-select a region approximating a neighborhood with fewer arithmetic operations, so that the number of sum of squared calculations is applied only to that subset:

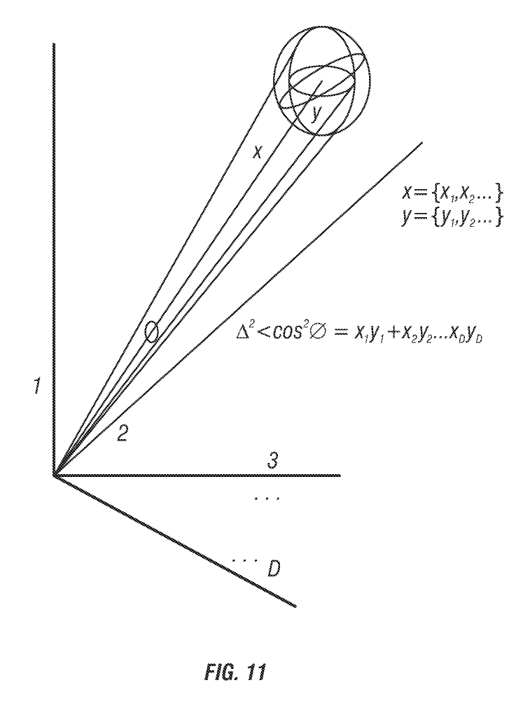

a. Squared cosine distance within a threshold: this represents a narrow D-dimensional hypercone from the origin and is calculated from an orthonormal basis by evaluating dot products xᵢ·yᵢ (each one is D multiplications and D additions). See FIG. 11.

b. Testing each yᵢ is within a D-hypercubical neighborhood, or range threshold of target xᵢ, consisting of at lost 2D comparisons, xᵢ−Δ<yᵢ<xᵢ+Δ

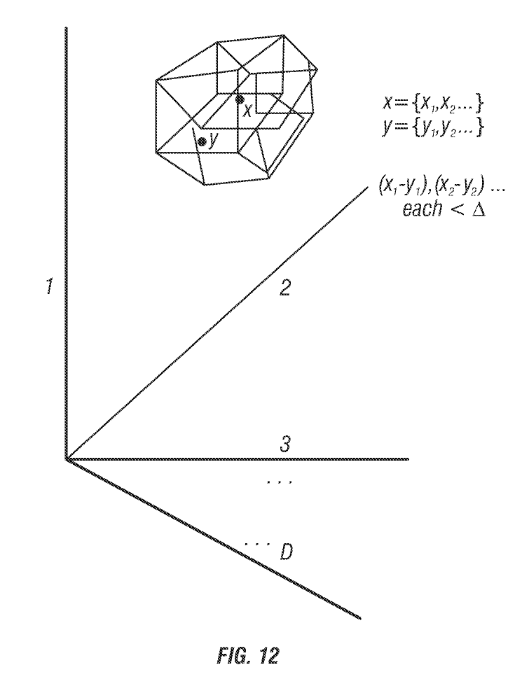

See FIG. 12. Note that we can use a bit set representation of the coordinates, and achieve this result through XOR operations as well.

With orthogonal basis vectors, we can use one of the simpler calculations to determine that two documents are within a desired range without using the more computationally intensive metric originally outlined, and then test the remnant to eject the false positives.

### Topics and Subtopics

It might be that a topic begins and ends inside another topic. Such a topic is referred to as a subtopic. The invention also extends to both topic and subtopic analysis by extending out from a key idea:

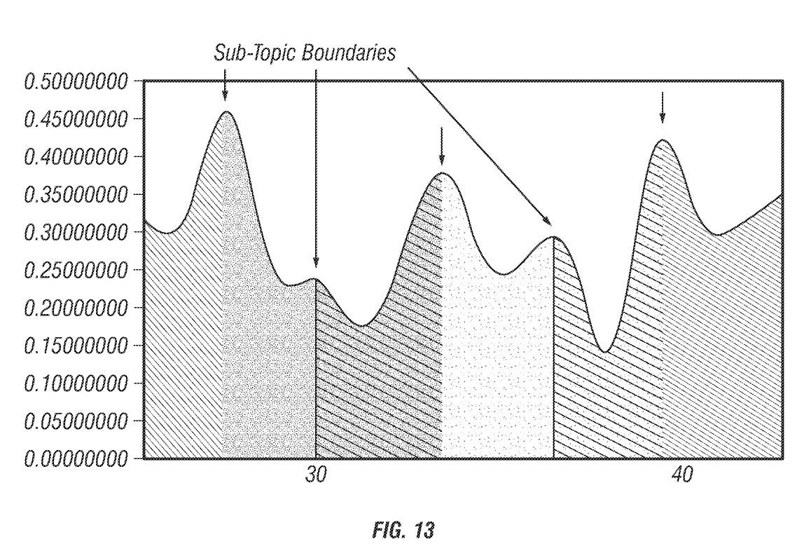

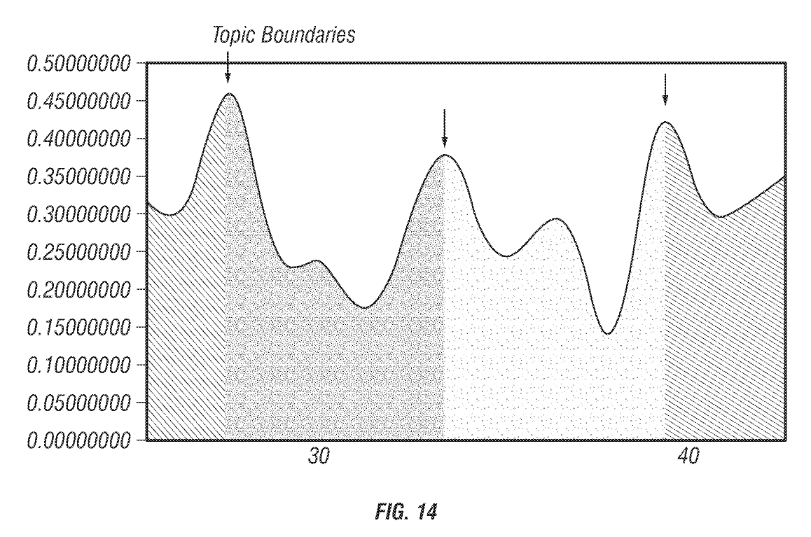

The passages forming a subtopic have greater semantic cohesion than the surrounding passage, and follow a trend to have a lower semantic density. The passages forming a subtopic are also bordered by local maxima, but of a smaller size. See FIGS. 13 and 14.

By a size invariant metric the method compares the semantic similarity of entire documents to extracted topics and to other documents. In addition, topics can be categorized in a multidimensional space by distance computations relative to a set of canonical documents or document passages which can serve as normal or axial vectors. See FIG. 1. An appropriate coordinate categorization as a vector in a multidimensional space attached to each document as metadata in the document storing systems allows a document and all its topics to be compared to other documents and topics quickly. The computation of the multidimensional square-root-of-sum-of-squares distance from the metadata serves as a much faster approximation of the more computationally intensive semantic metrics. Using a range threshold or cosine distance is computationally faster, and can be used to isolate a small subset against which the square-root-of-sum-of-squares distance may be applied. See FIGS. 11, 12.

### Application and Use of Invention: User Navigation Prediction

As part of preparation for this Invention, we have done considerable research into how topic boundaries and other characteristics of documents may be modeled so that they may be used to predict user navigation.

1. For usability and applications involving recommendation engines, optimization of user experience and the like, it is useful to model page or section transitions between pages or sections within a document, and transitions between documents. Topics can add an additional factor to this.

2. Informally, we can call things “relations,” such as:

a. The transition to the next page, or

b. The next page in a topic or in a chapter, or,

c. Less likely, backing up to reread the previous page, etc.

And these relations can be assigned a weight: meaning there is a typical likelihood for a document of a certain type in a certain collection to be pursued in a certain order.

3. In a same vein, we can say loosely that there is a certain likelihood of skipping to a chapter heading or the start of a topic, and these sort of things we call “characteristics” (because these reference only a target page and do not reference an origin page). These can also be assigned a weight as well. We can construct these values using a variety of inputs. Inputs for criteria might include (a by no means exhaustive list):

a. Topics. There may be more than one topic in a given corpus. Particular topics, either determined by the above, or assigned by human researchers, or by automated processes could be used. In addition to topics, we can also use:

b. Subject. Determined by Dewey Decimal or Library of Congress classifications, keywords in title, available metadata, human categorization, point of origin, etc.

c. Genre. Collection, archive, whitepaper, scholarly journal, journal article, prospectus, pamphlet, monograph, book, fiction/non-fiction, textbook, etc.

d. Metadata. Publisher, chapter headings, references, abstracts, etc. Topics can provide a substitute to decorate a document poor in metadata.

e. Search results. Subset of collection topic for a particular common search. (In addition, we could attach “popular search hits” to the set of characteristic functions for documents.)

f. Semantic distance. Determine metric so that documents can be clustered in an abstract semantic space algorithmically. Nearby documents in clusters would be natural candidates for different weighting models.

4. Given an interaction history for a collection of typical documents, we can assign these weights and make future predictions for a variety of purposes.

5. The key point is that we can use relations and characteristics to calculate transition probability matrices for user interactions from these weights.

6. Successive transitions can be modeled using Markov chains.

7. Optimizations and features can be modeled with this in relation to costs and benefits, and selective behavior can be initiated based on outcome of calculations.

### Computer Implementation

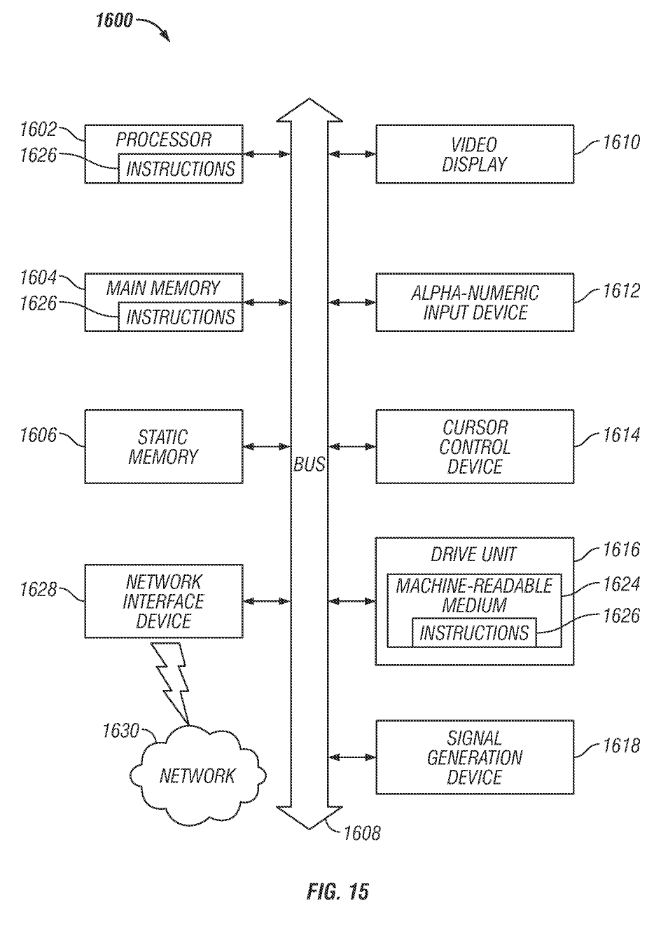

FIG. 15 is a block schematic diagram of a machine in the exemplary form of a computer system 1600 within which a set of instructions for causing the machine to perform any one of the foregoing methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for calculating topical categorization of electronic documents in a collection, comprising:
processor application of a metric to categorize semantic distance between two sections of a document or between two documents;
said processor executing a topic algorithm using the categorization provided by said metric to automatically determine topic boundaries;
said processor extracting topics based upon said topic boundaries; and
said processor comparing said extracted topics for similarity with topics in other documents for organizational and research purposes.

2. The method of claim 1, said topic algorithm using variational behavior of semantic distances to calculate topical categorization.

3. The method of claim 1, said topic algorithm using recursive division and differential adhesion based on semantic distances to calculate topical categorization.

4. The method of claim 1, said topic algorithm using both variational behavior of semantic distances, and recursive division and differential adhesion based on semantic distances to calculate topical categorization.

5. The method of claim 1, said topic algorithm detecting topic changes within clear breaks indicated by any of sentence breaks, chapter headings and metadata.

6. The method of claim 1, said document comprising any data in the form of a sequence of meaningful tokens that can be represented digitally or that can be expressed in the form of such a sequence.

7. The method of claim 6, said document comprising any of text, musical passages, choreography, and mathematics.

8. The method of claim 1, said topic algorithm determining topic boundaries for any of:
detecting similarity and/or transitions of meaning in passages where an intended meaning is opaque to an analyzer;
detecting similarity and/or transitions and related passages in an unknown script;
analyzing similarity and/or transitions of purported extraterrestrial signals;
detecting similarity and/or transitions in technical and mathematical papers;
providing an element of search or document discovery;
detecting unexpected, more valuable results based on topics;
identifying unexpected correspondences in research;
finding related passages in an unknown script;
supporting social recommendation engines; and
detecting plagiarism.

9. The method of claim 1, said topic algorithm supplying chapter and/or heading generation for documents that do not possess chapters and/or headings.

10. The method of claim 1, said topic algorithm categorizing said topics in a multidimensional space by a distance determined relative to a canonical set, or are used as generators of a canonical set, of document topics which serve as axes in said multidimensional space.

11. The method of claim 1, said topic algorithm stochastically selecting a canonical set of document topics.

12. The method of claim 1, further comprising:
applying one or more compression algorithms to compute compression size alone.

13. The method of claim 12, said one or more compression algorithms taking into account self-compression overhead of compressing absolutely identical data.

14. The method of claim 1, said topic algorithm taking into account a scaling measure that is independent of the size of objects of comparison.

15. The method of claim 1, further comprising:
using said topic algorithm to carry out a calculation of topic boundaries pursuant to a document sketch technique.

16. The method of claim 1, further comprising:
testing the effectiveness of parameters used by said topic algorithm by variation against a non-sequitur document term of art.

17. The method of claim 1, wherein said topic algorithm is independent of a normalized compression metric.

18. The method of claim 1, further comprising:
adjusting a computed topic boundary using a topic algorithm in text documents to a nearest sentence or section bound.

19. The method of claim 1, further comprising:
using an embodied metric to isolate most typical gist sentences within topics.

20. The method of claim 1, further comprising:
creating an orthonormal basis for a multi-dimensional topic space of a linear combination of topics using a random or prescribed topic sample and normalization using orthogonalization schemes comprising any of a stabilized Gram-Schmidt process, Householder transformations, and Givens rotations.

21. The method of claim 1, further comprising:
using a Euclidean metric for search and discovery of related topics in a collection of documents.

22. The method of claim 1, further comprising:
using cosine distance and, thereafter, a Euclidean metric for search and discovery of related topics in a collection.

23. The method of claim 1, further comprising:
using range threshold, within which each component of the coordinate needs to fall, and, thereafter, a Euclidean metric for search and discovery of related topics in a collection.

24. The method of claim 1, further comprising:
using topics to determine one of a number of types of significant document transitions;
using significant document transitions to predict user behavior by assigning weights to transition types and/or by calculating a transition matrix of probabilities using said weights; and
constructing cost/benefit models for storing and retrieving sections of documents from large collections of documents.

25. An apparatus for calculating topical categorization of electronic documents in a collection, comprising:
a processor configured for applying a metric to categorize semantic distance between two sections of a document or between two documents;
said processor configured for executing a topic algorithm using the categorization provided by said metric to automatically determine topic boundaries;
said processor configured for extracting topics based upon said topic boundaries; and
said processor configured for comparing said extracted topics for similarity with topics in other documents for organizational and research purposes.

26. The apparatus of claim 25, said topic algorithm using variational behavior of semantic distances to calculate topical categorization.

27. The apparatus of claim 25, said topic algorithm using recursive division and differential adhesion based on semantic distances to calculate topical categorization.

28. The apparatus of claim 25, said topic algorithm using both variational behavior of semantic distances, and recursive division and differential adhesion based on semantic distances to calculate topical categorization.
